(19) United States
(12) Patent Application Publication
(10) Pub. No.: US 2006/0087067 A1
(43) Pub. Date: Apr. 27, 2006

(54) CUTTING BOARD WITH OVERMOLDED THERMOPLASTIC ELASTOMER FEET

(76) Inventor: Ellis N Shamoon, Dallas, TX (US)

Correspondence Address: DANIEL V. THOMPSON, 9330 LBJ FWY., SUITE 1185, DALLAS, TX, 75243, US

(21) Appl. No.: 10/904,139

(22) Filed: Oct. 26, 2004

(51) Int. Cl. B23Q 3/00

(52) U.S. Cl. 269/289 R

(57) ABSTRACT

A cutting board has a planar top cutting surface and overmolded thermoplastic elastomer (TPE) feet on a bottom planar surface.

### TECHNICAL FIELD

The present invention relates to kitchen devices, and more particularly to a cutting board adapted for nonskid usage on a workspace.

### BACKGROUND ART

It is generally the practice in the kitchens of restaurants and homes to cut and wash foods such as vegetables in preparation for cooking and serving them. Usually a cutting board is utilized for preparation of the vegetables and other foodstuffs. The conventional cutting board is made of material which can withstand the cutting action of knives and the like and is generally large and heavy enough to remain stationary during cutting pressure and motions. Larger, heavy cutting boards, while efficient in use, are generally bulkier and more inconvenient to handle and wash than smaller and lighter weight cutting boards. However, smaller, lighter weight cutting boards generally have a tendency to move under heavy cutting action and therefore require stabilizing.

It would be an advantage therefore to overcome certain of the problems and inconveniences of prior art apparatus by providing an improved kitchen cutting board which can be effectively stabilized during use.

U.S. Pat. No. 6,478,292 to Sellers discloses a layered cutting board having top cutting layer and a bottom traction layer with feet. The top layer is relatively hard in order to take cutting action, while the bottom layer is flexible and rubbery to inhibit slipping. The bottom traction layer is substantially coextensive with the top layer on one side, where it is fixed to the cutting layer, and has feet extending from the other side. This construction is difficult to manufacture and requires a relatively large amount of rubbery traction layer material.

U.S. Pat. No. 6,702,273 to Sellers discloses a non-skid cutting board of wood, with rubbery feet attached to the bottom of the wooden cutting board with special mounting plates.

Thermoplastic elastomer (TPE) overmolding is a relatively new injection molding technique used to impart a “soft-touch” feel to tools and appliances such as screwdrivers and knives. A soft rubbery TPE section is typically overmolded onto a harder thermoplastic substrate layer, providing a soft-touch gripping surface and visually directing the user to the optimal places for gripping the tool. TPE overmolding has not heretofore been used to form non-skid surfaces on cutting boards.

### SUMMARY OF THE INVENTION

The cutting board of the present invention has a planar top cutting surface and overmolded TPE feet on a bottom planar surface.

### BRIEF DESCRIPTION OF THE DRAWINGS

A more complete understanding of the invention and its advantages will be apparent from the Detailed Description taken in conjunction with the accompanying Drawings, in which:

FIG. 1 is a front-top perspective view of a cutting board.

FIG. 2 is a side view of the cutting board.

FIG. 3 is a bottom view of the cutting board.

FIG. 4 is a partial sectional view taken along lines 4-4 of FIG. 1.

FIG. 5 is a partial perspective view of a first alternate embodiment of a foot.

FIG. 6 is a partial perspective view of a second alternate embodiment of a foot.

### DETAILED DESCRIPTION OF THE PREFERRED EMBODIMENT

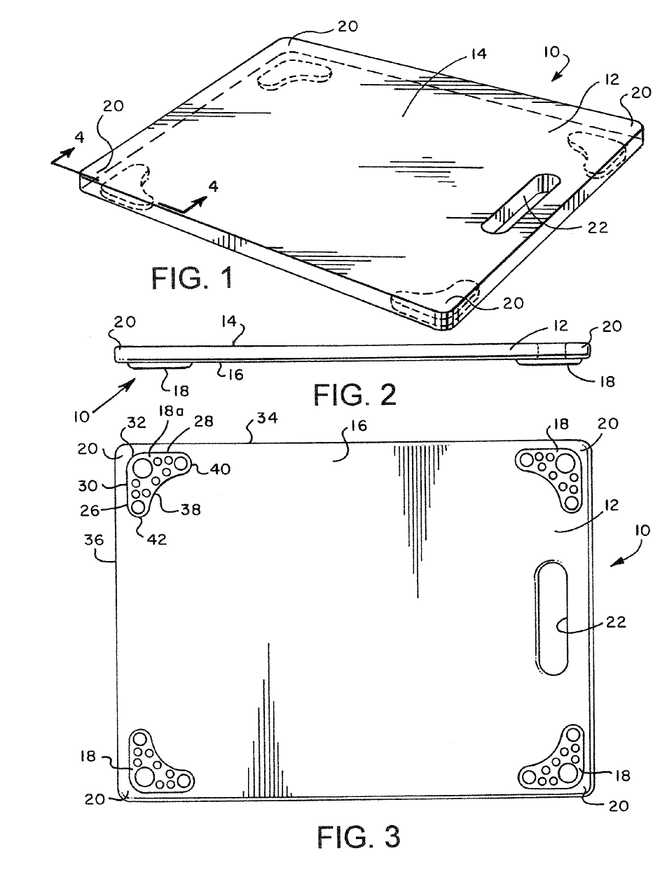

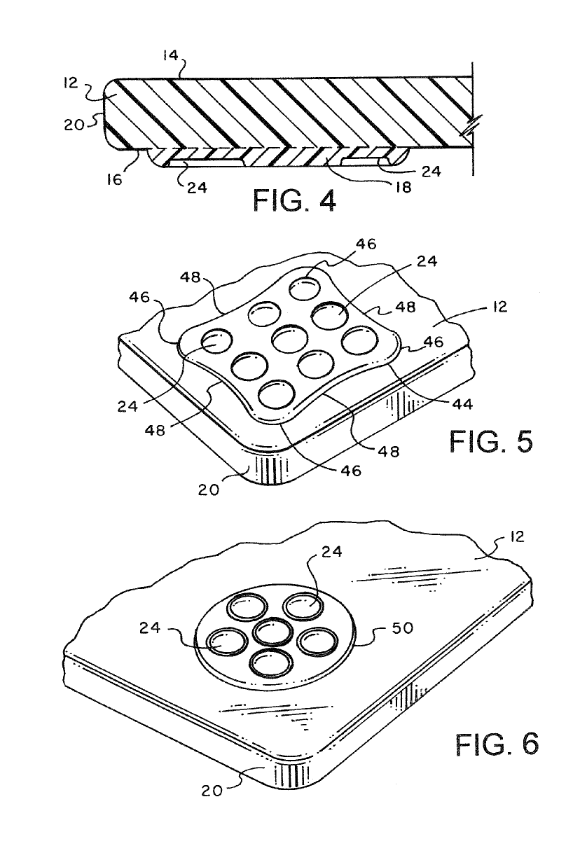

Referring to FIGS. 1-6, where like numerals indicate like and corresponding elements, cutting board 10 is provided for use in kitchens in the preparation of foods. The cutting board 10 includes a main body 12 having a planar top cutting surface 14 and a bottom planar surface 16. The main body 12 is formed of a first thermoplastic material such as polyethylene. The material is chosen from the group of engineering plastics that are known to bond well with thermoplastic elastomers (TPE), such as acrylic, styrene, standard/modified nylons and PC/ABS-based plastics among other materials.

A plurality of feet 18 are formed of thermoplastic elastomer (TPE) and overmolded directly onto the bottom planar surface 16 of the main body 12.

In the preferred embodiment illustrated, the main body 12 is rectangular with four corners 20, and the feet 18 are located in the corners 20. A handle aperture 22 may optionally be provided.

Each of the feet 18 preferably has a plurality of outwardly-facing indentations 24. Indentations 24 prevent the feet 18 from “hydroplaning” on a wet surface by providing voids where moisture can migrate as the cutting board 10 is placed down. A slight suction cup function is also performed by indentations 24. Indentations 24 are circular in horizontal cross-section.

Several foot perimeter shapes are possible. As shown in FIGS. 1-4, each of the feet can have a generally triangular perimeter 26. The four feet 18 are identical in shape, and in reference to typical foot 18a in FIG. 3, two straight sides 28,30 are at a right angle joined by a rounded vertex corner 32, with the straight sides 28,30 being parallel to sides 34,36 of the main body. An inwardly-curved hypotenuse side 38 is joined to the straight sides 28,30 by rounded corners 40,42. As shown in FIG. 5, each of the feet can have a generally square perimeter 44, with four rounded corners 46 and four inwardly- curved sides 48. As shown in FIG. 6, each of the feet 18 can have a circular perimeter 50.

A number of factors known to one of ordinary skill in the plastic molding art must be considered when manufacturing this invention. These factors include selection of insert molding vs. multi-shot molding, material selection, and part/mold design as to thickness, texture, part ejection, shut-off and venting.

It will be understood that each of the elements described above, or two or more together, may also find a useful application in other types of constructions differing from the type described above.

While the invention has been illustrated and described as embodied in a braking systems, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

Whereas, the present invention has been described with respect to a specific embodiment thereof, it will be understood that various changes and modifications will be suggested to one skilled in the art and it is intended to encompass such changes and modifications as fall within the scope of the appended claims.

1. A cuttingboard for use in kitchens in the preparation of foods, the cuttingboard comprising:
a main body having a planar top cutting surface and a bottom planar surface, the main body adapted for generally horizontal positioning, the main body formed of a first thermoplastic material; and
a plurality of feet formed of thermoplastic elastomer overmolded directly onto the bottom planar surface of the main body.

2. The cuttingboard of claim 1 with main body being rectangular with four corners, and the feet being located in the corners.

3. The cuttingboard of claim 1 with each of the feet having a plurality of outwardly-facing indentations.

4. The cuttingboard of claim 3 with the indentations being circular in horizontal cross-section.

5. The cuttingboard of claim 2 with each of the feet having a plurality of outwardly-facing indentations.

6. The cuttingboard of claim 5 with the indentations being circular in horizontal cross-section.

7. The cuttingboard of claim 2 with the each of the feet having a circular perimeter.

8. The cuttingboard of claim 2 with the each of the feet having a generally square perimeter, with four rounded corners and four inwardly-curved sides.

9. The cuttingboard of claim 2 with the each of the feet having a generally triangular perimeter, with two straight sides at a right angle joined by a rounded vertex corner, the straight sides being parallel to sides of the main body, and an inwardly-curved hypotenuse side joined to the straight sides by rounded corners.

10. The cuttingboard of claim 9 with each vertex corner being located in close juxtaposition to a corner of the main body.

11. The cuttingboard of claim 7 with each of the feet having a plurality of outwardly-facing indentations.

12. The cuttingboard of claim 11 with the indentations being circular in horizontal cross-section.

13. The cuttingboard of claim 8 with each of the feet having a plurality of outwardly-facing indentations.

14. The cuttingboard of claim 14 with the indentations being circular in horizontal cross-section.

15. The cuttingboard of claim 9 with each of the feet having a plurality of outwardly-facing indentations.

16. The cuttingboard of claim 16 with the indentations being circular in horizontal cross-section.

17. The cuttingboard of claim 10 with each of the feet having a plurality of outwardly-facing indentations.

18. The cuttingboard of claim 17 with the indentations being circular in horizontal cross-section.
